(19) United States
(12) Patent Application Publication
(10) Pub. No.: US 2022/0315282 A1
(43) Pub. Date: Oct. 6, 2022

(54) STACKABLE/NESTED CONTAINER

(71) Applicant: HEINRICH REINDORF MALM, Catlett, VA (US)

(72) Inventor: HEINRICH REINDORF MALM, Catlett, VA (US)

(21) Appl. No.: 17/706,593

(22) Filed: Mar. 29, 2022

Related U.S. Application Data
(60) Provisional application No. 63/167,734, filed on Mar. 30, 2021.

(51) Int. Cl. B65D 21/02; B65D 23/08

(52) U.S. Cl. CPC B65D 21/0231; B65D 23/085

(57) ABSTRACT

Described herein is a stackable/nested container assembly. The assembly is comprised of a plurality of containers having a shape configured to be cooperatively nested and stacked together with an upper portion received within an external cavity of a lower portion. The upper portion of the containers including a locking indent and a locking bump to form redundant and cohesive locking mechanism for the nested receipt of cooperating containers.

### CROSS-REFERENCE TO RELATED APPLICATION

This patent application claims priority to U.S. Provisional Patent Application No. 63/167,734 filed Mar. 30, 2021 and titled “Stackable/Nested Flowable Liquid Container”, to the above-named inventor, the disclosure of which is considered part of the disclosure of this application and is hereby incorporated by reference in its entirety.

### FEDERALLY SPONSORED RESEARCH OR DEVELOPMENT

Not Applicable.

### SEQUENCE LISTING, A TABLE, OR A COMPUTER PROGRAM

Not Applicable.

### FIELD OF THE INVENTION

The invention relates generally to a stackable container configured to enable the nesting of individual containers in a cooperative assembly. More particularly, the invention provides a container, such as a bottle, having an upper portion configured for receipt within a lower portion in a nested assembly, wherein a plurality of individual containers are configured for a nested and stacked assembly when desired.

### BACKGROUND

The disposable water bottle has been one of the more ubiquitous containers in our world. These bottles take up a significant amount of space and are often packaged and sold in large bulk wrapped packaging. Due to their prevalence and generally large storage and shelf footprint, it would be desirable to have an improved container shape. Preferably this container shape is amenable to the carrying and transport of multiple bottles in a cohesive assembly.

### SUMMARY OF THE INVENTION

The invention is most generally directed to a co-operative container assembly described as a stackable/nested container with at least a pair of containers having features to enable nesting in a stacked configuration.

The device of the present disclosure is most generally comprised of a container with a shape defined by a plurality of sidewalls to generally form an interior cavity and an external cavity within the container for containing a material. The plurality of sidewalls having a continuous and cohesive shaped structure to form the container. The container plurality of sidewalls at least defining an upper portion, a lower portion, and a middle portion generally connecting the upper portion and the lower portion.

The upper portion corresponding to a position that can be designated as a top of the container and includes a lid portion. The lid portion providing access to the interior cavity and provided in a shape that is amenable to pouring or drinking from the container. The lid portion preferably including a cap. The cap configured for removable placement on the lid portion.

The upper portion having a generally tapered and terraced shape with at least a pair of locking members within this terraced shape to register and secure a companion container device when nested. Accordingly, the at least a pair of locking members is comprised of a locking indent and a locking bump. Each of the locking indent and the locking bump extending around an entire circumference of the upper portion to aid the securing and locking of cooperating devices in a nested assembly. The locking indent is an indentation within the sidewall of the container upper portion generally having an arcuate shape. The locking indent is positioned below the lid portion and generally represents a first securing means for the nested fitment of cooperating devices.

The locking bump can be described as generally proud or raised relative to the sidewalls of the container upper portion, wherein the locking bump can alternately be described as a circumferential ridge or an annular ring extending around the entire circumference of the container upper portion. The locking bump is positioned below the locking indent relative to the lid portion, wherein the locking bump generally represents a second securing means for the nested fitment of cooperating devices. Accordingly, the locking bump and locking indent provide a redundant securing means that includes registration and secure engagement of nested devices in a cooperating and stacked assembly.

The lower portion generally representing a bottom of the container and including the external cavity. The external cavity extending inward to the container interior space opposite the lower portion towards the upper portion. The external cavity having a shape corresponding to the upper portion, wherein the upper portion is configured for a locking and secure fitment within the external cavity of the lower portion of a cooperating container in the nested assembly. Accordingly, this external cavity has a generally terraced shape in relief and includes a locking indent ridge for fitment within the locking indent and a locking bump groove configured for the receipt of the locking bump in a secure fitment.

Each of the locking indent ridge and the locking bump groove extending around an entire circumference of the external cavity sidewalls to aid the securing and locking of cooperating devices in a nested assembly. The locking indent ridge can be described as generally proud or raised towards an interior space of the external cavity, wherein the locking indent ridge has a shape corresponding to the locking indent for securely receiving the locking indent ridge within the locking indent.

The locking bump groove is an indentation or relief within the sidewall of the exterior cavity and generally has an arcuate and cooperating shape for receipt of the locking bump in a nested fitment of cooperating devices.

In the preferred assembly, three separate container devices are provided in a stacked and nested assembly with a singular label surrounding the three nested devices. The label having perforations and a tab aligned with this stacked assembly to enable a user to peel the label along the perforation through manipulation of the tab to allow the user the ability to separate the cooperating and stacked devices from the assembly. Alternate to peeling, the perforations also allow for easy break-off/snap-off, with a little pressure/effort for separation and with a little pressure also allows for push-on/tap to attach/join individual containers, if necessary. Accordingly, the perforations allow for two options on how the containers are separated; either by the peeling the perforated means or with a little pressure—by breaking off.

In an alternate embodiment, the stacked assembly of cooperating devices can be utilized for the placement of a unique and small container lacking the external cavity of the main container. This small container is anticipated to be best utilized as a measuring device for a fluid within the container or an alternate container for more concentrated fluids. The small container generally mirrors the upper portion of the main container, wherein it is capable of nesting within the lower portion of a cooperating container. Accordingly, the small container is most generally comprised of a shape defined by a plurality of sidewalls to generally form an interior cavity within the small container for containing a material, such as, but not limited to a liquid, fluid, or powder. The plurality of sidewalls having a continuous and cohesive shaped structure to form the container. The small container plurality of sidewalls at least defining an upper portion and a bottom generally being flat and culminating at the upper portion.

In the preferred assembly of the small container, the small container includes graduation lines to indicate an amount of fluid within the small container, wherein the small container may be used as a measuring device for fluids that require measurement such as, but not limited to, medicines and performance beverages.

The device container and small container are preferably constructed from a disposable and recyclable material, such as, but not limited to, plastics, selected to generally allow for some resiliency and flexion, wherein locking bumps or the locking indents are generally enabled to flex slightly to enable a secure engagement. Although disposable and recyclable materials are preferred, the device can be produced from a variety of materials without departing from the spirit and scope of the disclosure.

In the preferred assembly of the present disclosure, the stackable assembly of the device is provided with three (3) containers in a nested configuration bound by a single label with perforations corresponding to the individual container size, wherein the perforations allow for easy separation of individual containers within the assembly for use.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a side view of the assembled device with label, according to the present disclosure;

FIG. 2 is side view of a single container, according to the present disclosure;

FIG. 3 is a side view of a single container with hidden features shown, according to the present disclosure;

FIG. 4 is side view of the assembled device without the label, according to the present disclosure;

FIG. 5 is a side view of an assembled device with hidden features shown, according to the present disclosure;

FIG. 6 is an isometric view of an assembled device, according to the present disclosure;

FIG. 7 is a side view of the small container, according to the present disclosure;

FIG. 8 is an isometric view of the small container, according to the present disclosure;

FIG. 9 is an isometric view of the small container, according to the present disclosure; and

FIG. 10 is an isometric view of the container showing the hidden features, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention is most generally directed to a co-operative container assembly described as a stackable/nested container with at least a pair of containers having features to enable nesting in a stacked configuration.

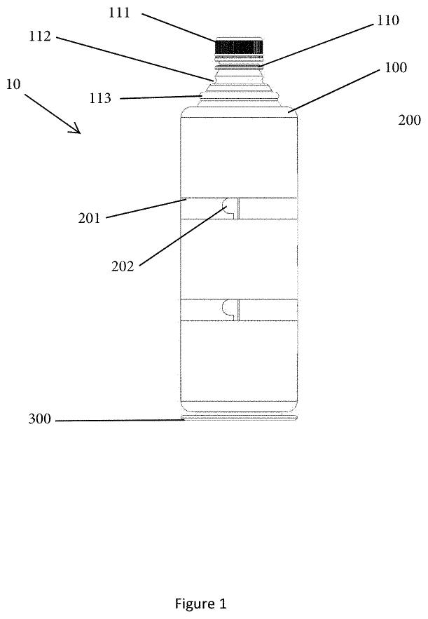

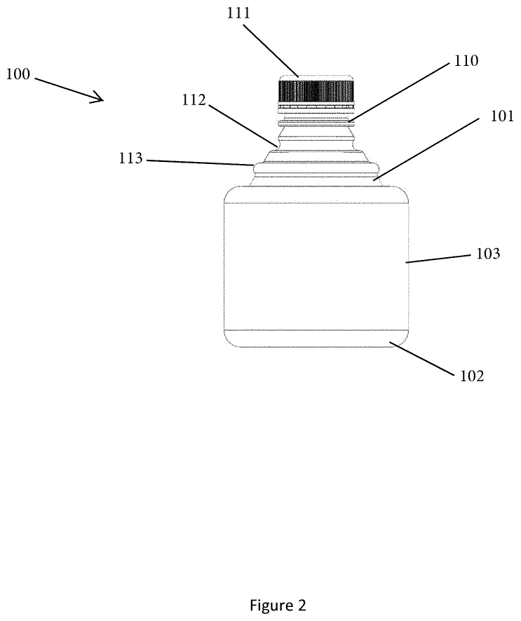

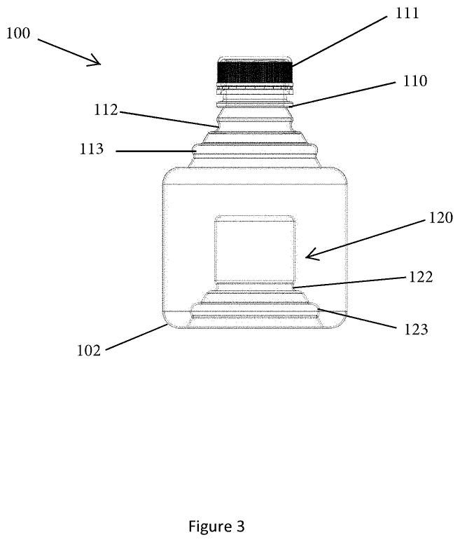

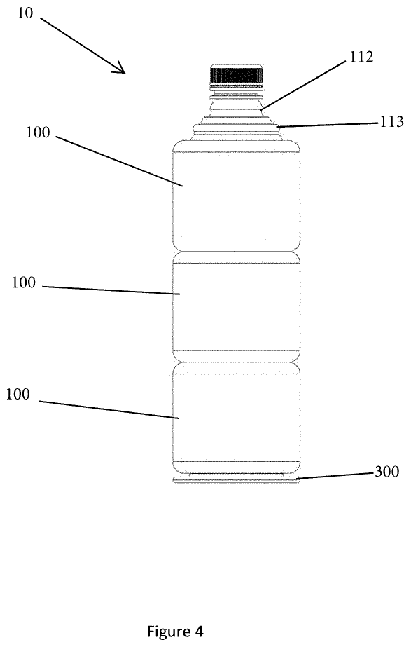

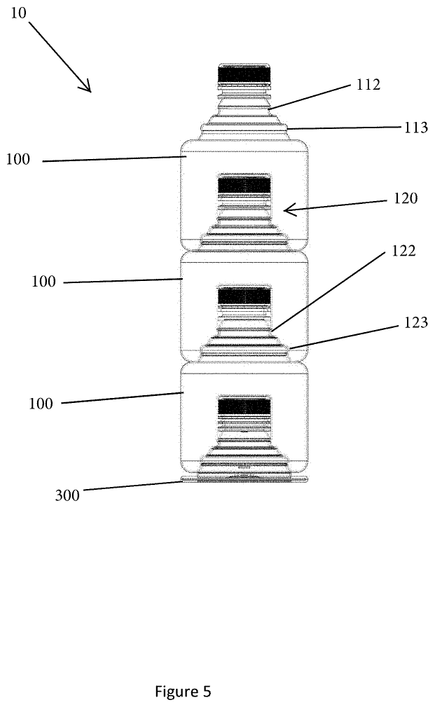

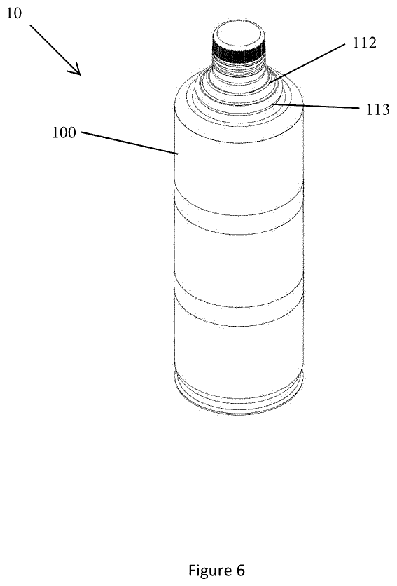

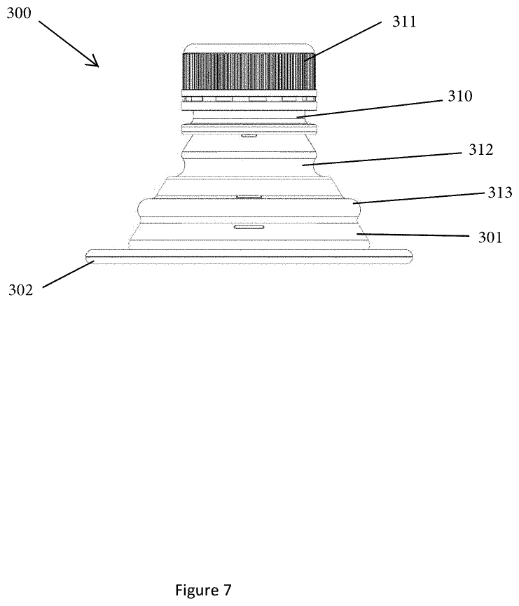

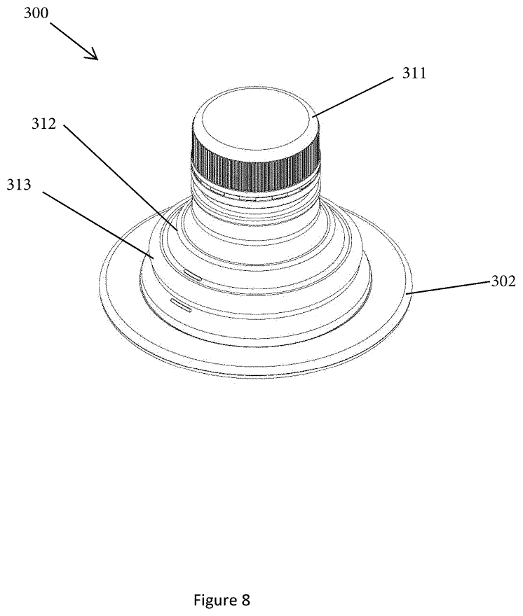

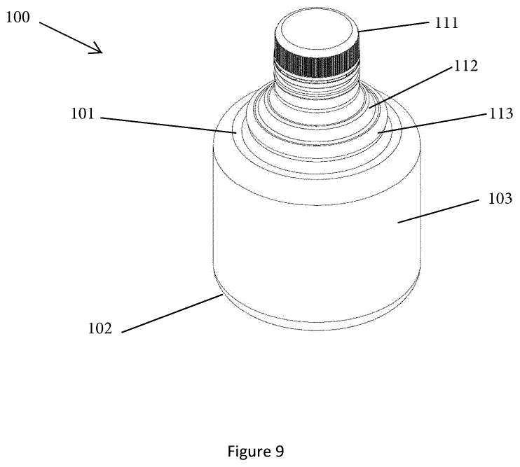

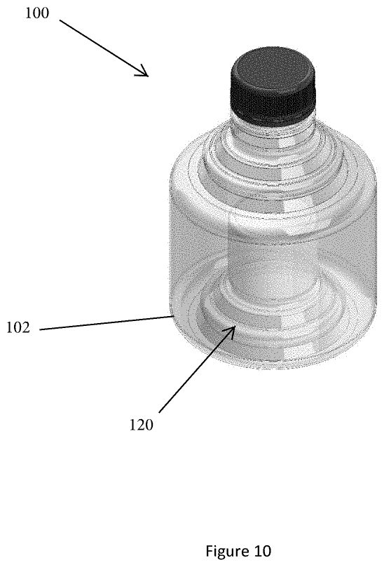

Referring now to the figures, FIG. 1-FIG. 10 show the stackable/nested container assembly according to the present disclosure and generally referred to herein as device 10. The device 10 of the present disclosure is most generally comprised of a container 100 with a shape defined by a plurality of sidewalls to generally form an interior cavity and external cavity 120 within the container 100 for containing a material. The plurality of sidewalls having a continuous and cohesive shaped structure to form the container 100. The container 100 plurality of sidewalls at least defining an upper portion 101, a lower portion 102, and a middle portion 103 generally connecting the upper portion 101 and the lower portion 102.

The upper portion 101 corresponding to a position that can be designated as a top of the container 100 and includes a lid portion 110. The lid portion 110 providing access to the interior cavity and provided in a shape that is amenable to pouring, drinking, or generally adding or removing a material from the container 100. The id portion 110 preferably including a cap 111. The cap 111 configured for removable placement on the lid portion 110, preferably, but not limited a threaded receipt, wherein the cap 111 seals the container 100 when desired.

The upper portion 101 having a generally tapered and terraced shape with at least a pair of locking members 112, 113 integrated within this terraced shape to register and secure a companion device 10 when nested. Accordingly, the at least a pair of locking members 112, 113 is comprised of a locking indent 112 and a locking bump 113. Each of the locking indent 112 and the locking bump 113 extending around an entire circumference of the upper portion 101 to aid the securing and locking of cooperating devices 10 in a nested assembly. The locking indent 112 is an indentation within the sidewall of the container 100 upper portion 101 generally having an arcuate shape. The locking indent 112 is positioned below the lid portion 110 and generally represents a first securing means for the nested fitment of cooperating devices 10.

The locking bump 113 can be described as generally proud or raised relative to the sidewalls of the container 100 upper portion 101, wherein the locking bump 113 can alternately be described as a circumferential ridge or an annular ring extending around the entire circumference of the container 100 upper portion 101. The locking bump 113 is positioned below the locking indent 112 relative to the lid portion 110, wherein the locking bump 113 generally represents a second securing means for the nested fitment of cooperating devices 10. Accordingly, the locking bump 113 and locking indent 112 provide a redundant securing means that includes registration and secure engagement of nested devices 10 in a cooperating and stacked assembly.

The lower portion 102 generally representing a bottom of the container 100 and including the external cavity 120. The external cavity 120 extending inward to the container 100 interior space opposite the lower portion 102 towards the upper portion 101. The external cavity 120 having a shape corresponding to the upper portion 101, wherein the upper portion 101 is configured for a locking and secure fitment within the external cavity 120 of the lower portion 102 of a cooperating container 100 in the nested assembly. Accordingly, this external cavity 120 has a generally terraced shape in relief and includes a locking indent ridge 122 for fitment within the locking indent 112 and a locking bump groove 123 configured for the receipt of the locking bump 113 in a secure fitment.

Each of the locking indent ridge 122 and the locking bump groove 123 extending around an entire circumference of the external cavity 100 sidewalls to aid the securing and locking of cooperating devices in a nested assembly. The locking indent ridge 122 can be described as generally proud or raised towards an interior space of the external cavity 120, wherein the locking indent ridge 122 has a shape corresponding to the locking indent 112 for securely receiving the locking indent ridge 122 within the locking indent 112.

The locking bump groove 123 is an indentation or relief within the sidewall of the exterior cavity 120 and generally has an arcuate and cooperating shape for receipt of the locking bump 113 in a nested fitment of cooperating devices 10.

In the preferred assembly, three separate container devices 10 are provided in a stacked and nested assembly with a singular label 200 surrounding the three nested devices 10. The label 200 having perforations 201 and a tab 202 aligned with this stacked assembly to enable a user to peel the label 200 along the perforation 201 through manipulation of the tab 202 to allow the user the ability to separate the cooperating and stacked devices 10 from the assembly. Alternate to peeling, the perforations 201 also allow for easy break-off/snap-off, with a little pressure/effort for separation and with a little pressure also allow for a push-on/tap to attach/join individual containers, if necessary. Accordingly, the perforations 201 allow for two options on how the containers are separated; either by the peeling the perforated 201 means or with a little pressure—by breaking off.

In an alternate embodiment, the stacked assembly of cooperating devices 10 can be utilized for the placement a unique and small container 300 lacking the external cavity 120 of the main container 100. This small container 300 is anticipated to be best utilized as a measuring device for a fluid within the container 100 or an alternate container for more concentrated fluids. The small container 300 generally mirrors the upper portion 101 of the main container 100, wherein it is capable of nesting within the lower portion 102 of a cooperating container 100. Accordingly, the small container 300 is most generally comprised of a shape defined by a plurality of sidewalls to generally form an interior cavity within the small container 300 for containing a material, such as, but not limited to, a fluid. The plurality of sidewalls having a continuous and cohesive shaped structure to form the container 300. The small container 300 plurality of sidewalls at least defining an upper portion 301 and a bottom 302 generally being flat and culminating at the upper portion 301.

The upper portion 301 corresponding to a position that can be designated as a top of the small container 300 and includes a lid portion 310. The lid portion 310 providing access to the interior cavity and provided in a shape that is amenable to pouring or transferring a material from the small container 300. The lid portion 310 preferably including a cap 311. The cap 311 configured for removable placement on the lid portion 310, preferably, but not limited a threaded receipt, wherein the cap 311 seals the small container 300 when desired.

The upper portion 301 of the small container 300 having a generally tapered and terraced shape with at least a pair of locking members 312, 313 integrated within this terraced shape to register and secure the small container 300 within the exterior cavity 120 of a companion container 100 device 10 when nested. Accordingly, the at least a pair of locking members 312, 313 mirror the container 100 upper portion 101 and is comprised of a locking indent 312 and a locking bump 313. Each of the locking indent 312 and the locking bump 313 extending around an entire circumference of the small container 300 upper portion 301 to aid the securing and locking within the exterior cavity 120 in a nested assembly. The locking indent 312 is an indentation within the sidewall of the small container 300 upper portion 301 generally having an arcuate shape. The locking indent 312 is positioned below the lid portion 310 and generally represents a first securing means for the nested fitment within the exterior cavity 120 of a cooperating container 100.

The small container 300 locking bump 313 can be described as generally proud or raised relative to the sidewalls of the small container 300 upper portion 301, wherein the locking bump 313 can alternately be described as a circumferential ridge or an annular ring extending around the entire circumference of the small container 300 upper portion 301. The small container 300 locking bump 313 is positioned below the locking indent 312 relative to the lid portion 310, wherein the locking bump 313 generally represents a second securing means for the nested fitment within the external cavity 120 of cooperating container 100 devices 10. Accordingly, the locking bump 313 and locking indent 312 provide a redundant securing means that includes registration and secure engagement in a nested assembly.

In the preferred assembly of the small container 300, the small container 300 includes graduation lines to indicate an amount of fluid or other material within the small container 300, wherein the small container 300 may be used as a measuring device for materials that require measurement such as, but not limited to, medicines, powders, and performance beverages.

Alternately, to this preferred assembly, the container 100 and small container 300 could only utilize one locking mechanism in the form of the locking bumps 113, 313 or the locking indents 112, 312. Still alternately, the device 10 container 100 and small container 300 could be provided in a locking or nested assembly that requires more than two distinct locking mechanisms.

The device 10 container 100 and small container 300 are preferably constructed from a disposable and recyclable material, such as, but not limited to, plastics or other materials selected to generally allow for some resiliency and flexion, wherein locking bumps 113, 313 or the locking indents 112, 312 are generally enabled to flex slightly to enable a secure engagement. Accordingly, this fitment is expected to be secure and tight, wherein the nested receipt of cooperating containers 100, 300 requires force to allow for separation and attachment during nesting.

In the preferred assembly of the present disclosure, the stackable assembly of the device 10 is provided with three (3) containers 100 in a nested configuration bound by a single label 200 with perforations 201 corresponding to the individual container 100 size, wherein the perforations 201 allow for easy separation of individual containers 100 within the assembly for use.

In the preferred assembly of the present disclosure, the device 10 shape is specifically selected to include a generally tapered or slanted surface with the at least a pair of locking members 112, 113 integrated within this slanted or terraced shape to register and secure a companion device 10 when nested. Accordingly, the at least a pair of locking members 112, 113 comprising the locking indent 112 and the locking bump 113 can be posited anywhere along the upper portion 101 including the lid portion 110 or the cap 111. Accordingly, to generally mirror this preferred shape and ensure proper nesting, the lower portion 102 external cavity 120 also includes a shape that is generally terraced or slanted and can receive the locking indent 112 and the locking bump 113 wherever they are placed on the upper portion 101.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A stackable/nested container amenable to nesting when desired, the container comprising:
a sidewall generally defining a container shape with an interior cavity for holding a material, the sidewall comprising:
an upper portion, the upper portion having a terraced shape including a locking indent and a locking bump; and
a lower portion, the lower portion having an external cavity extending from a bottom of the sidewall towards the upper portion, the lower portion external cavity having a shape corresponding to the upper portion and including a locking indent ridge and a locking bump groove, wherein the locking indent ridge and locking bump groove are configured for the cooperative receipt of the locking indent and the locking bump of a cooperating container in a nested position.

2. The container of claim 1, wherein the upper portion includes a lid portion.

3. The stackable/nested container of claim 2, wherein the upper portion lid portion includes a cap.

4. The stackable/nested container of claim 1, wherein the upper portion locking indent and locking bump each extend an entire circumference of the container.

5. The stackable/nested container of claim 4, wherein the locking indent ridge and locking bump groove each extend the entire circumference of the container.

6. A stackable/nested container assembled from a plurality of distinct and separate containers in a stacked and nested configuration, the assembly comprising:
a plurality of containers, each container comprising:
a sidewall, the sidewall being continuous and generally defining a container shape with an interior cavity for holding a material;
an upper portion, the upper portion having a terraced shape including a locking indent and a locking bump; and
a lower portion, the lower portion having an external cavity extending from a bottom of the sidewall towards the upper portion, the lower portion external cavity having a shape corresponding to the upper portion and including a locking indent ridge and a locking bump groove, wherein the locking indent ridge and locking bump groove are configured for the cooperative receipt of the locking indent and the locking bump of a cooperating container in a nested position; and
a label, the label surrounding the assembly.

7. The stackable/nested container assembly of claim 6, wherein each container of the plurality of containers upper portion includes a lid portion.

8. The stackable/nested container assembly of claim 7, wherein each container of the plurality of containers upper portion lid portion includes a cap.

9. The stackable/nested container assembly of claim 6, wherein each container of the plurality of containers upper portion locking indent and locking bump each extend an entire circumference of each container.

10. The stackable/nested container assembly of claim 9, wherein each container of the plurality of containers locking indent ridge and locking bump groove each extend the entire circumference of each container.

11. The stackable/nested container assembly of claim 6, wherein the label includes perforations, the perforations corresponding to a height of each container in the nested assembly.

12. The stackable/nested container assembly of claim 6, wherein the assembly comprises at least three containers.

13. The stackable/nested container assembly of claim 12, wherein the assembly includes a small container, the small container having an upper portion, the upper portion having a terraced shape including a locking indent and a locking bump.

14. A stackable/nested container assembled from a plurality of distinct and separate containers in a stacked and nested configuration, the assembly comprising:
a first container, the first container having:
a sidewall, the sidewall being continuous and generally defining a first container shape with an interior cavity for holding a material;
an upper portion, the upper portion having a terraced shape including a locking indent and a locking bump; and
a lower portion, the lower portion having an external cavity extending from a bottom of the sidewall towards the upper portion, the lower portion external cavity having a shape corresponding to the upper portion and including a locking indent ridge and a locking bump groove, wherein the locking indent ridge and locking bump groove are configured for the cooperative receipt of the locking indent and the locking bump of a cooperating container in a nested position;
a second container, the second container having:
a sidewall, the sidewall being continuous and generally defining a second container shape identical to the first container shape with an interior cavity for holding a material;
an upper portion, the upper portion having a terraced shape including a locking indent and a locking bump; and
a lower portion, the lower portion having an external cavity extending from a bottom of the sidewall towards the upper portion, the lower portion external cavity having a shape corresponding to the upper portion and including a locking indent ridge and a locking bump groove, wherein the locking indent ridge and locking bump groove are configured for the cooperative receipt of the locking indent and the locking bump of a cooperating container in a nested position;
a third container, the third container having:
a sidewall, the sidewall being continuous and generally defining a third container shape identical to the first container shape with an interior cavity for holding a material;
an upper portion, the upper portion having a terraced shape including a locking indent and a locking bump; and
a lower portion, the lower portion having an external cavity extending from a bottom of the sidewall towards the upper portion, the lower portion external cavity having a shape corresponding to the upper portion and including a locking indent ridge and a locking bump groove, wherein the locking indent ridge and locking bump groove are configured for the cooperative receipt of the locking indent and the locking bump of a cooperating container in a nested position, wherein the second container upper portion is received within the exterior cavity of the first container and the third container upper portion is received within the exterior cavity of the second container; and
a label, the label surrounding the assembly.

15. The stackable/nested container assembly of claim 14, wherein each container of the first container, second container, and third container upper portions includes a lid portion.

16. The stackable/nested container assembly of claim 15, wherein each container of the first container, second container, and third container upper portions includes a cap.

17. The stackable/nested container assembly of claim 14, wherein each container of the first container, second container, and third container upper portions locking indent and locking bump each extend an entire circumference of each container.

18. The stackable/nested container assembly of claim 17, wherein each container of the first container, second container, and third container upper portions locking indent ridge and locking bump groove each extend the entire circumference of each container.

19. The stackable/nested container assembly of claim 14, wherein the assembly includes a fourth container, the fourth container being a small container, the small container having an upper portion, the upper portion having a terraced shape including a locking indent and a locking bump, wherein the fourth container upper portion is received in the exterior cavity of the third container.

20. The stackable/nested container assembly of claim 14, wherein the fourth container, being a small container is used as a measuring cup.
